(19) United States
(12) Patent Application Publication
(10) Pub. No.: US 2017/0330299 A1
(43) Pub. Date: Nov. 16, 2017

(54) ONLINE RECOMMENDATION OF PUBLIC SERVICES

(71) Applicant: SAP SE, Walldorf (DE)

(72) Inventor: Markus SCHMIDT-KARACA, Heidelberg (DE)

(21) Appl. No.: 15/155,153

(22) Filed: May 16, 2016

(51) Int. Cl. G06Q 50/26; G06F 17/30; G06Q 10/06; G06Q 30/06

(52) U.S. Cl. CPC G06Q 50/26; G06Q 30/0631; G06F 17/30864; G06Q 10/067

(57) ABSTRACT

A method of system for recommending services for users based on user related information. The recommendation of services employs a model generated using master user related data of users of the system. The model analyzes user related data of the user to provide a recommendation list of services in which the user needs and for which the user qualifies.

### TECHNICAL FIELD

The present disclosure relates generally to intelligent tools. In particular, an intelligent tool which recommends public sector services, such as social services, to users online

### BACKGROUND

Public services play an important role in socioeconomic development as well as improving social order. For example, social programs are implemented to help maintain a healthy society and economy by providing funds to those in need while regulations are needed to maintain safety and social order. Other benefits are enjoyed for public services as well.

However, the plethora of public services makes it difficult to understand or even appreciate which services are needed or are available to an individual. Moreover, the services are offered by different agencies; increasing barrier of accessing the services due to significant inconvenience. Furthermore, different services have different qualification requirements which may not be known to an individual. In some cases, an individual may not even be aware of services for which he/she is qualified for.

From the foregoing discussion, it is desirable to provide a convenient access to and information for services as well as recommending services for which are qualified.

### SUMMARY

A method of recommending services is described herein. The method includes collecting user related information of users of a recommendation system which forms master user related data. The recommendation system includes a list of available services provided by the recommendation system. A model is generated by the recommendation system by analyzing the master user related data. The user accesses the recommendation system by using a user interface on a user device. The recommendation system is used to determine whether there is user related data of the user. If there is user related data of the user, a list of recommended services is generated based on the user related data using the model. If there is no user related data, the list of recommended services is generated based on a default list of recommended services. The list of recommended services is displayed to the user on the user interface of the user device.

In one embodiment, a system for recommending services is disclosed. The system includes a frontend sub-system which serves as a platform for the system. The frontend sub-system includes a questionnaire unit to provide a user with a questionnaire to answer. The frontend sub-system also includes a service recommender unit which displays a list of recommended services from available services provided by the system. The list of recommended services is based on user related data, if available. If no user related data is available, a default list is used. The system further includes a backend sub-system which includes a database module and a processor module. The database module includes the available services of the system and master user related data of users of the system. The processor module includes a recommender runtime unit. A model in the runtime unit is used to analyze the user related data of the user to generate the list of recommended services which is passed to the services recommender unit.

In another embodiment, a non-transitory computer-readable medium having stored thereon program code which is executable by a recommendation system is disclosed. The program code includes collecting user related information of users of the recommendation system which forms master user related data. The recommendation system includes a list of available services provided by the recommendation system. A model is generating by the recommendation system by analyzing the mater user related data. The user accesses the recommendation system by using a user interface on a user device. The recommendation system is used to determine whether there is user related data of the user. If there is user related data of the user, a list of recommended services is generated based on the user related data using the model. If there is no user related data, the list of recommended services is generated based on a default list of recommended services. The list of recommended services is displayed to the user on the user interface of the user device.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures. Like reference numerals in the figures designate like parts.

FIG. 1 shows an embodiment of an environment;

FIG. 2 shows an embodiment of a recommendation system architecture;

FIG. 3 shows an embodiment of a workflow for a recommendation system;

FIG. 4 shows an embodiment of a screen layout of a UI for the recommendation system;

FIG. 5 shows a flow for generating user related data;

FIG. 6 shows a process for developing and deploying a model;

FIG. 7 shows a flow for generating a recommendation list of services; and

FIG. 8 shows an exemplary embodiment of a questionnaire.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of present frameworks and methods, and to thereby better explain the present frameworks and methods. Furthermore, for ease of understanding, certain method steps are delineated as separate steps; however, these separately delineated steps should not be construed as necessarily order dependent or being separate in their performance.

A framework or application for recommending public services is described herein. Public services, for example, include services by government or public service agencies. Such services may include social programs, such as healthcare, housing, and welfare as well as other types of social programs. For example, other programs may include but are not limited to citizen services, parking permit services, pet licensing services, driving licensing services, student services, tax and revenue services and grantor management services.

The framework may be an online interactive framework. For example, the framework may be for a user in need of services. The framework recommends services based on information regarding the user. The information may be obtained by various techniques. For example, the information may be provided by the user through a user registration process, a questionnaire, data mining of available websites (e.g., social networks) and continuous use of the framework, including interactions and applying for services. User information may also be obtained from other data sources. Of course, it is understood that the information is obtained through publicly accessible data sources which are not subject to privacy or legal restrictions.

Analysis is performed on the available user information provided to generate a list of recommended services. The analysis may be based on a predictive model. Alternatively, the analysis may be based on a rule based model. The framework presents the list of recommended services to the user. The user may select the desired services using the framework.

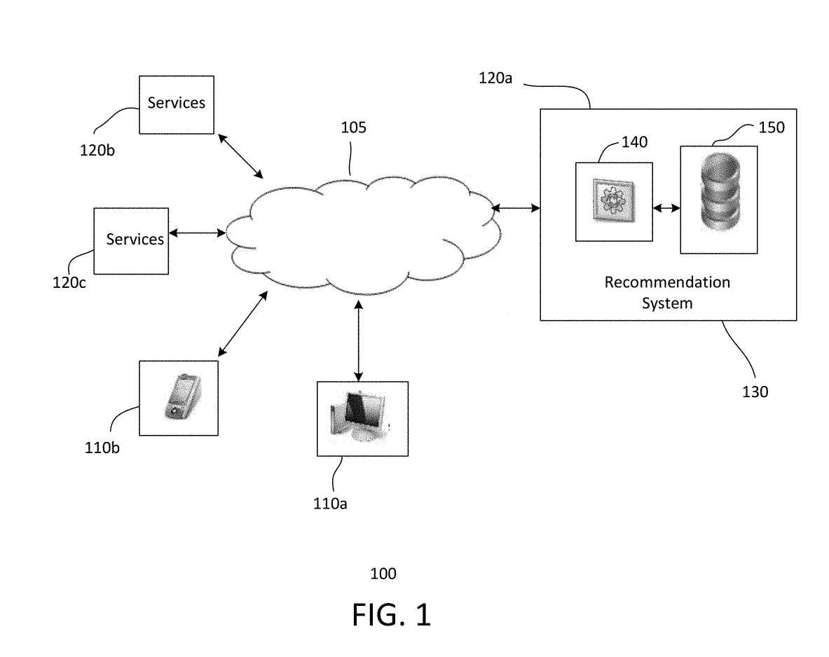

FIG. 1 shows an exemplary environment 100. The environment, for example, facilitates recommendations of public services. In one embodiment, the environment includes a communication network 105. The communication network may be, for example, the internet. Other types of communication networks or combination of networks may also useful. As shown, the environment includes a plurality of servers 120a-c and client devices 110a-b coupled to the communication network.

A server may include one or more computers. A computer includes a memory and a processor. Various types of computers may be employed for the server. For example, the computer may be a mainframe, a workstation as well as other types of processing devices. The memory of a computer may include any memory or database module. The memory may be volatile or non-volatile types of non-transitory computer-readable media such as magnetic media, optical media, random access memory (RAM), read-only memory (ROM), removable media, or any other suitable local or remote memory component.

In the case where the server includes more than one computer, they are connected through a communication network such as an internet, intranet, local area network (LAN), wide area network (WAN), internet or a combination thereof. The servers, for example, may be part of the same private network. The servers may be located in single or multiple locations. Other configurations of servers may also be useful. For example, the servers may form a cloud.

As for client or user devices, they may be any computing devices. A computing device, for example, includes a local memory and a processor. The computing device may further include a display. The display may serve as an input and output component of the user device. In some cases, a keyboard or pad may be included to serve as an input device. The memory may be volatile or non-volatile types of non-transitory computer-readable media such as magnetic media, optical media, RAM, ROM, removable media, or any other suitable memory component. Various types of processing devices may serve as user devices. For example, the client devices may include a personal computer (client 110a), or a mobile client device such as a smart phone (client 110b). Other types of user devices, such as laptops or tablets may also be useful.

A user may connect to a server using a client device. The user device may be referred to as the client side while the server may be referred to as the server side. A user may access the server by logging in the user's respective account with, for example, a password using a client device. The client device may have an application interface or user interface (UI) which is used to communicate with the server. Alternatively, a web browser on the client device may be used. Other techniques for accessing the server may also be useful.

In one embodiment, the environment includes a service recommendation system 130. The service recommendation system, for example, resides on a server (server 120a). In one embodiment, the service recommendation system includes a processor module 140 and a database module 150. The database module includes information for processing by the processor module. The database module, for example, may be an in-memory database, such as SAP HANA database. Other types of databases may also be useful.

The recommendation system may be an online interactive system for recommending services. For example, a user may access the recommendation system though the user's client device. The user device may include a user interface (UI). The UI may be a web-based UI. For example, the UI is displayed on the user device when the web page of the recommendation system is visited by the user. Alternatively, the UI may be an application-based (App-based) UI. For example, the UI may be displayed when the App of the recommendation system is invoked. The UI may also run in the background without being displayed. For example, the UI may adopt the layout dynamically based on the recommendation given.

The recommendation system may be available to registered user as well as to non-registered users. For example, the system does not require a user to be registered with the recommendation system in order to use it. A registered user may log in to the recommendation system using the UI. Alternatively, a user may be an anonymous user. For example, an anonymous user may be a user who has not yet registered or a registered user who is using the recommendation system without being logged in.

The database module may include user information of different registered users. The user information may include various types of user information which can be obtained by various techniques. The user information, for example, may include information provided by the users directly and indirectly internal to the recommendation system as well information obtained through data mining external to the recommendation system. For example, user information may be obtained from external sources, such as public and private data sources through data mining For example, information can be obtained through social networks, government networks, as well as other types of networks or data sources. The user information may be referred to as master user related data which includes related data of all registered users.

Regarding information provided by the user directly, it may include personal information provided during the registration process. Such information, for example, may include name, gender, birthday, marital status, number of children, income level, interests, employment information, such as profession and employer. Other information may also be included as part of the registration process. In addition, information may be provided from a questionnaire when a user accesses the recommendation system. The questionnaire, for example, may be an optional questionnaire for the user to fill. The questionnaire may include information such as services interested by the user. Such services may include insurance types (e.g., health insurance, life insurance, auto insurance and fire insurance), citizen services, parking permit, dog license, driving license, tax and revenue management, public education, social programs (e.g., housing welfare, and subsidies), as well as other types of services.

As for information provided by the user indirectly, it may include user information accumulated through continuous use of the recommendation system. For example, information may be obtained through recorded user interactions. User interactions may include screen interactions with the UI, selection of services recommended by the recommendation system, services applied for by the user and response by the agency of the service, such as denial, approval or other types of responses regarding the applications or benefits.

In some cases, master user related data may include information from non-registered users as well as registered users. However, with respect to non-registered user data, it may be only a subset of the registered user data since data from the registration process will be excluded. For example, data from non-registered users may include answers to questionnaires, if any, as well as indirectly obtained user information. The recommendation system may assign unique anonymous user IDs for non-registered users.

The UI may facilitate in obtaining information form a user. For example, user profile information may be obtained when the user registers with the recommendation system through the UI. Also, when a user accesses the system through the UI, a questionnaire may be provided to the user. The user may optionally answer the questionnaire. The questionnaire may be a wizard-based questionnaire; requesting answers to questions from the user. Using other techniques for obtaining user information may also be useful.

As described, the user information is collected and stored in the database module to be part of the user related data of the master user related data of all users. The processor module analyzes the user related data and provides recommended services. The recommended services may be based on a model developed using master user related data of the registered users. In some cases, the recommended services may be based on a model developed using master user related data of all the users, including registered and non-registered users. The model, in one embodiment, is a predictive model. In other embodiments, the model is a rule based model. Other types of models may also be useful.

In one embodiment, the recommended services are ranked based on likelihood of need by the user according to the predictive model. For example, the recommended services may be provided as a list according to rank. The list may be from the highest rank to the lowest. The list may be presented to the user through the UI. For example, the top X ranked services may be presented to the user. For example, X may be 10. Providing other values of X may also be useful. In some cases, the UI may present 4-5 recommended services at a time to the user.

The recommendation system may serve as a portal. For example, the list of recommendations may link to the home pages of the different recommended services. Different home pages of the recommended services may be located on different servers, such as servers 120b and 120c.

As described, the recommendation system provides recommended services targeted to a specific user based on, for example, the user information. Furthermore, the recommendation system increases simplicity by providing access to different services.

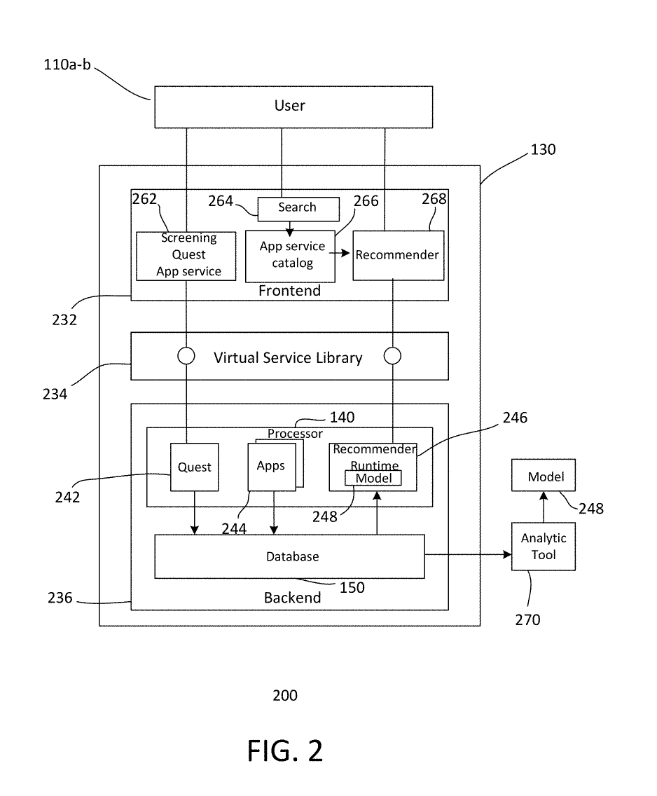

FIG. 2 shows an architectural diagram 200 of an embodiment of a recommendation system 130. In one embodiment, the recommendation system includes a frontend sub-subsystem 232, a backend sub-system 236 and a virtual service library sub-system 234. Providing the recommendation system with other sub-systems may also be useful.

The frontend sub-system may serve as a platform of the recommendation system. For example, the frontend sub-system includes screen components of a user interface (UI) of the recommendation system. A user may interact with the frontend sub-system through a client device 110a-b. The backend sub-system stores user information and performs analysis of the user information to generate recommended services targeted to the user. As for the virtual service library sub-system, it enables decoupling of the frontend and backend sub-systems. In one embodiment, the virtual service library includes various ODATA services which enable communication between the frontend and backend sub-systems. The various sub-systems may reside on one or more servers. For example, the sub-systems may reside on different servers or on the same server. Other configurations of the sub-systems may also be useful.

In one embodiment, the UI is a web-based UI. For example, the frontend sub-system may be located in a server. A user accesses the UI through a browser on the client device. For example, the home page of the recommendation system may be accessed through the browser. In other embodiments, the frontend sub-system may be an application (App) residing on the client or user device. The UI may be accessed by invoking the App. Other configurations of the UI may also be useful.

As shown, the UI includes various units. In one embodiment, the UI includes a screening questionnaire unit 262, a search unit 264, a service catalog unit 266 and a service recommender unit 268. In one embodiment, the questionnaire unit, the search unit and service recommender unit correspond to screen elements of the UI. Providing other types of units may also be useful. For example, the frontend sub-system may include a login unit, corresponding to the screen element. The login unit is used to log in to the system.

The catalog unit, for example, contains a list of available services through the service recommendation system. In one embodiment, the catalog is an application service. The application service encapsulates the database that stores the data exposed through the service. For example, the database contains the list of services available through the service recommendation system. In one embodiment, the services available through the service recommendation system are provided as Apps, such as App services. An App service is a single purpose UI for applying or requesting a specific service. For example, an App service is a link to the site of the associated service offered. In one embodiment, an App service is provided for each service which is available through the recommendation system. The service catalog contains App services of available services through the recommendation system. In addition, the service catalog may include forms for related services.

The search unit 264 may be a search engine. The search unit may be a search box in a search area of the UI screen layout. In one embodiment, the search unit searches the service catalog unit 266 using keyword searching.

As for the screening questionnaire unit 262, it contains a list of questions to a user. In one embodiment, the screening questionnaire unit is an App service. For example, a link may be provided in the search area which calls the questionnaire App service. When clicking on the link, the questionnaire App service opens, for example, in an App service area of the UI screen display. The questionnaire App service may be a form based App service. For example, a form with a list of questions is provided in the App service area.

The questions of the questionnaire, for example, relate to types of interested services. Such services may include insurance types, such as health insurance, life insurance, auto insurance and social programs, such as welfare, subsidies as well as other types of services. Providing other types of information or questions may also be useful.

In one embodiment, the questionnaire App service includes questions regarding services available through the service recommendation system. For example, such questions include whether a user needs a specific service offered by the recommendation system. The questions may include radio buttons for yes or no answers. Other types of questionnaires may also be useful.

The questionnaire App service collects the answers to the questions and sends them to the backend sub-system via an ODATA service in the virtual service library sub-system. For example, the questionnaire App service is a publisher App service. The publisher App service publishes the questions and answers to the backend sub-system. For example, the questions and answers are stored in the database module in the backend sub-system.

The service recommender unit displays a list of services for the user to select in the recommender area of the UI. The list of services may be a list of App services related to recommended services for the user. In one embodiment, the service recommender unit may be a subscriber App service. For example, the subscriber App service may subscribe to the backend sub-system or search engine. The App service may subscribe to the backend sub-system through a recommender ODATA service in the virtual service library sub-system or the search engine to receive a list of App services when user information is provided via the questionnaire unit or a search is initiated

The recommended App services in the recommender area of the UI screen layout may be represented as icons. Representing the App services using other techniques may also be useful. A user may launch an App service by clicking on the icon. The App service may be launched, for example, inside an App service area of the UI. In one embodiment, the service recommender unit may be an App service. For example, the App service may be invoked to receive a list of App services when a search is initiated or user information is provided via the questionnaire unit.

The backend sub-system includes a processor module 140 and a database module 150. The database module may include an in-memory database, such as SAP HANA. Other types of databases may also be useful. The database stores information from the processor module and provides information for processing by the processor module.

As for the processor module 140, it includes a processor for processing information from and providing processed information to the frontend sub-system via ODATA service in the virtual service library sub-system. In one embodiment, the processor module receives questions and answers 242 from the screen questionnaire App service via a questionnaire ODATA service in the virtual service library sub-system. Different information from different users are stored. The information forms part of the master user related data in the database module.

The processor also receives application data 244. The application data is data obtained when user applies for a service. Different applications for services provide application data which is stored in the database. In addition, application data and responses from the applications for services are stored in the database module and form part of the mater user related data. As discussed, the master user related data may include other types of data, such as data from data mining of external data sources. The data from data mining may be provided by a data mining or data acquisition module (not shown). The data mining module may be a separate or an integrated module of the backend sub-system.

The processor module includes a recommender runtime unit 246. The runtime unit includes a model 248. The model is developed based on the master user related data. In one embodiment, a model is developed for each service which is available or offered to a user through the recommendation system. The runtime unit 246 analyzes user related data to generate a list of App services to recommend to the frontend sub-system via the recommender ODATA service in the virtual service library sub-system.

In one embodiment, the model 248 is a predictive model. The predictive model is generated by an analytic tool 270 which analyzes the master user related data stored in the database. The predictive model is provided to the recommender runtime unit. Using the predictive model, the recommender runtime unit predicts App services which the user would desire or need based on the user related data of the user. The App services are then recommended to the user. In one embodiment, the recommended App services are ranked based on a probability score determined by the model. If no user related data is available, a default list of recommended services may be provided.

In some embodiments, the model is a rule-based model. The rule-based model may be generated by an analytic tool 270 which analyzes the master user related data stored in the database to generate rules. After the model is generated, it is provided to the recommender runtime unit 246. Using the rule-based model, the recommender runtime unit generates a list of recommended App services to the user based on user related data of the user. The recommended App services are ranked based on a score determined by the model. If no user related data is available, a default list of recommended services may be provided.

The analytic tool 270, as shown, is separate from the backend sub-system. Providing the analytic tool as part of the backend sub-system may also be useful. For example, the analytic tool may be part of the database module. The analytic tool utilizes the master user related data in the database to generate the model. In other embodiments, the analytic tool may be part of the frontend sub-system.

In one embodiment, the analytic tool 270 is a predictive analytic tool which is part of a predictive analysis library of the database module. For example, the predictive analytic tool may be from the predictive analysis library (PAL) or automated predictive library (APL) in SAP HANA. Other types of predictive analytic tools may also be useful.

In one embodiment, the analytic tool is a rule based analytic tool. The rule engine, for example, is part of a framework in the database module. In one embodiment, the rule engine is a Hana Rules Framework (HRF) in HANA database from SAP. In other embodiments, the rule engine may be a Business Rule Framework (BRF) or BRF Plus from SAP. These frameworks include UIs for defining rules. Other types of rules engines may also be useful. The input to the rule engines may be a table of question and answer pairs and the output is a table of services based on the table of question and answer pairs.

In one embodiment, when the user does not answer the questionnaire, a default list or standard set of services available is returned. On the other hand, if questions are answered, the set of questions and answers are passed to the rule model. This, for example, exposes a Remote Function Call (RFC) module. The rule model returns the list of recommended services based on the answers provided. The list of recommended services may be ranked based on likelihood of need or use. The answers to the questions, for example, are true or false answers. A “1” may represent “True” while a “blank” represents a “False”. The answers to the questionnaire may be stored in the database module. For example, answers to the questionnaire for registered users are stored while answers to questionnaire for non-registered users are used in the transient mode and are not stored. Storing answers to questionnaires for non-registered users may also be useful.

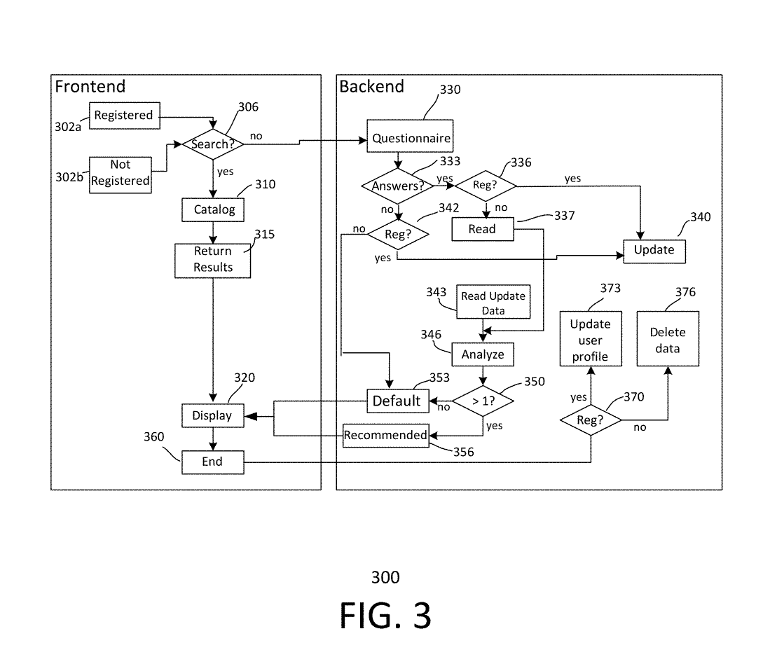

FIG. 3 shows a workflow 300 of an embodiment of a service recommendation system. The workflow illustrates which steps or processes are performed by the frontend sub-system and the backend sub-system. In one embodiment, the frontend sub-system includes an online mobile interaction platform. The platform, for example, may be an Online Mobile Interaction Platform (OMIP) from SAP Transaction Code OMIP. The backend sub-system may include a customer relationship management (CRM) system. The CRM system includes a processor module and a database module.

The recommendation system may be accessed using a browser of a client device. The homepage of the recommendation system may include a login section as well as an option to use the system as an unregistered user. A user may log in at step 302a if the user is a registered user. For example, a user may enter user ID and password in the logic section of the web page of the recommendation system. Registration may include providing the system with personal information, such as gender, age, birthday, address, annual income, family members as well as other information to set up the user profile. The user information is stored in the database in the backend sub-system, such as in the database module. Alternatively, a user may access the recommendation system as an anonymous or unregistered user at step 302b. For example, the UI may include a select button to select use by an unregistered user. In one embodiment, user related information for non-registered users is maintained by the system.

A user may decide to perform a search using key words at step 306. To perform a search, the user types key words in the search box and clicks on search command At step 310, the search engine searches the App service catalog using the key words entered by the user. The result of the search is returned at step 315. The result, for example, is a list of App services found based on the words. The App services are passed to the recommender App service at step 320. The recommender App service displays the App services in the result list in, for example, the recommender area of the UI. The App services may be represented as icons. Representing the App services in other forms may also be useful.

On the other hand, the user may select to answer a questionnaire provided by the recommendation system. The questionnaire is presented in the App service area of the UI when the user clicks on a link which launches the questionnaire App service. For example, the user may click on an “Advanced Search” option. The user may answer the questionnaire. The questions and answers, if any, are passed to the backend sub-system at step 330. The backend sub-system determines if the user answered the questionnaire or not at step 333. If the user answered the questionnaire, the answers serve as the current user related data. The flow proceeds to step 336.

At step 336, the backend sub-system determines if the user is a registered user or a non-registered user. If the user is a registered user, the flow proceeds to step 340. At step 340, the backend sub-system updates the current user related data with existing or prior user related data of the user in the database module. For example, the current and prior existing data are combined to form updated user related data for analysis. Prior user related data exists for a registered user at least from the registration process. The updated user related data is read at step 343. If the user is not a registered user, the flow proceeds to step 337 where the current user related data is read.

In the case where the user does not answer the questionnaire, the backend sub-system determines if the user is a registered user or a non-registered user at step 342. If the user is a registered user, the flow proceeds to step 340. At step 340, the backend sub-system updates the user related data with existing or prior user related data of the user in the database module. The updated user related data is read at step 343. On the other hand, if the user is not a registered user, the flow proceeds to step 353.

At step 346, the backend subsystem analyzes the user related data to generate a list of recommended App services which the user may use or need. In one embodiment, the data is analyzed using a predictive model in the recommender runtime unit. In another embodiment, a rule-based model is used to generate the list of recommended App services. The recommended services are ranked based on a score determined by the model. For example, the score indicates probability or likelihood of use or need by the user.

The recommendation list is analyzed to determine if it is empty or not at step 350. For example, the recommender runtime analyzes the recommendation list to determine if it is empty or not. If the list is empty, the backend sub-system proceeds to step 353. At step 353, the backend sub-system passes a default list of App services to the frontend sub-system. If the list is not empty, the backend sub-system proceeds to step 356 to pass the recommendation list of App services to the frontend sub-system. Passing the list to the frontend sub-system, whether it is the default list or the recommendation list, may be facilitated by recommender ODATA service in the virtual service library. At step 320, the recommender App service displays the list of App services from the backend sub-system in, for example, the recommender area of the UI.

When a user terminates a session at step 360, such as by logging out or exiting the home page of the recommendation system, the backend sub-system analyzes whether the user is a registered user or not at step 370. If the user is a registered user, the current user information is updated to the master user related information at step 373. In one embodiment, if the user is not a registered user, the data is deleted at step 376.

In another embodiment, user related data of non-registered users may be stored. For example, non-registered users may be assigned a unique non-registered user ID. In this case, although the user may be anonymous, user related data may still be captured. Such information may not include, for example, personal user information. However, personal user information of anonymous users may be captured if the anonymous user utilizes the services recommended by the recommendation services. The personal information may be updated to the anonymous user ID, rendering it non-anonymous.

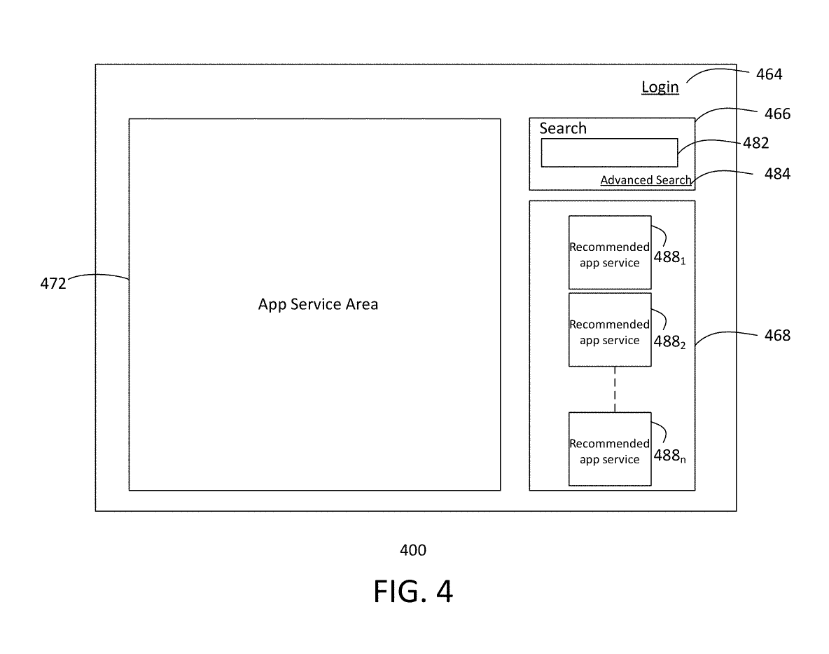

FIG. 4 shows an illustrative embodiment of a screen layout 400 of a UI. As shown, the layout includes a login area 464, a search area 466, a recommender area 468 and an App service area 472. Providing the layout with other areas may also be useful. In one embodiment, the layout may be divided into two main sections. For example, a first main section occupies a major section of the left side of the layout. The second main section occupies a remaining minor section on right side of the layout. The App service area occupies the first main section of the layer. The login area, search area and the recommender area occupy the second main section of the layout. In one embodiment, the search area is located above the recommender area. The recommender area occupies a major portion of the second main section. As for the login area, it is located above the search area. Other configurations of the layout, including additional areas, may also be useful.

The login area includes a login link. Clicking on the login link, for example, activates a login service App. The login service App may provide the user an option to log in to the system if the user is a registered user or to register as a user with the system if the user is a non-registered user. If the user is a registered user, the user may simply log in by entering the user ID and password. On the other hand, the user may select to register as a new user by clicking on a new user service App, which requests personal user information, including user ID and password.

In one embodiment, search area 466 includes a search box. A user may enter key words in the search box, which will search the service catalog unit by the search engine. The search area includes a link 484 for the questionnaire service App. The link for example, is the “Advanced Search” option. Clicking on the Advanced Search link launches the questionnaire service App in the App service area.

The recommender App service displays App services 488₁₋ₙ in the recommender area. The App services may be represented as icons. The App services may be recommended App services based on answers of the questionnaire or search results of the keyword search of the App service catalog unit. Clicking on the icon launches the App service in the App service area.

In one embodiment, the questionnaire App service is developed using a UI developer. For example, the Apps may be developed using SAP UI5. Developing the Apps using other developers may also be useful. The App services may be modeled as widgets in the HANA cloud portal. The questionnaire widget is the publisher widget and the recommender widget is a subscriber widget. For example, the questionnaire widget publishes or writes data, such as the question and answer pairs of the questionnaire, to the database module while the recommender widget subscribes to the recommender runtime widget. In one embodiment, if no question and answer pairs of a questionnaire are published, then the service recommender widget calls the runtime recommender to return a set of default services available.

On the other hand, if a user answers the questionnaire, the information is published by the questionnaire widget in the database. The recommender widget gets this information from the database and passes it to recommender runtime to return a list of recommended services based on the model. The service list is shown as the refined recommended services for the user. In the case the model does not provide any recommended services, the runtime returns a default list of services.

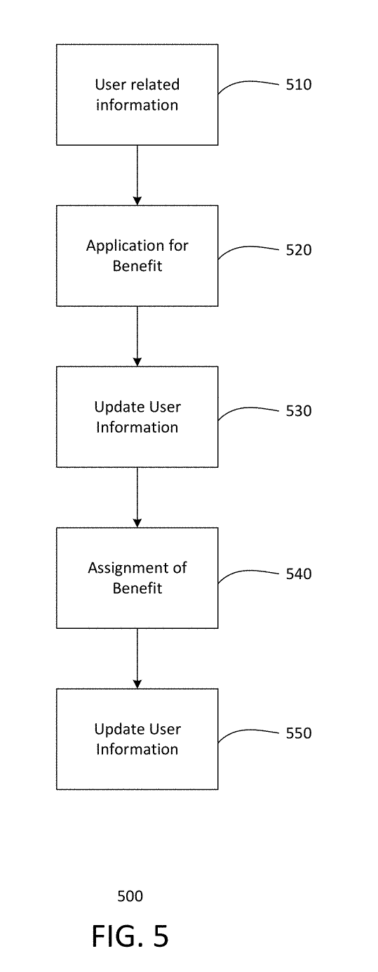

FIG. 5 shows an embodiment of a process flow 500 for generating user related information. At step 510, user information is provided. In one embodiment, the user related information may be provided by a user as part of a registration process. Additionally, user related information may be obtained through a questionnaire filled out by the user as well as through continued use of the recommendation system. As also discussed, user related information may also be obtained from external data sources through data mining

The user related information is used to generate a list of recommended services to the user. The list of recommended services is provided, for example, by the runtime recommender unit of the backend sub-system of the recommendation system using a model. The model may be a predictive model or a rule based model. The model is developed using the master user related data in the database module of the backend sub-system. The list of recommended services may be ranked based on likelihood of user or need as determined by the model.

The user may select a service from the list of recommended services at step 520. For example, the user may click on the App service of the service desired. The App service is launched in the App service area. The user may apply for the service or benefit selected. Information provided by the user is updated into the user related data of the user in the master related user data at step 530.

At step 540, the agency responsible for the service applied for provides a response. The response may be granting or denying the service or benefit. This response is updated into the user related data of the master user related data in the database module at step 550. Over time, the master user related data grows with continual use by users, as well as information provided by the user and through data mining of external data sources.

The process is repeated for each use by a user. As discussed, the model is based on the master user related data. As the use of the system increases, the amount of data grows. The model may be updated using the most current master user related data to maintain a current and accurate model.

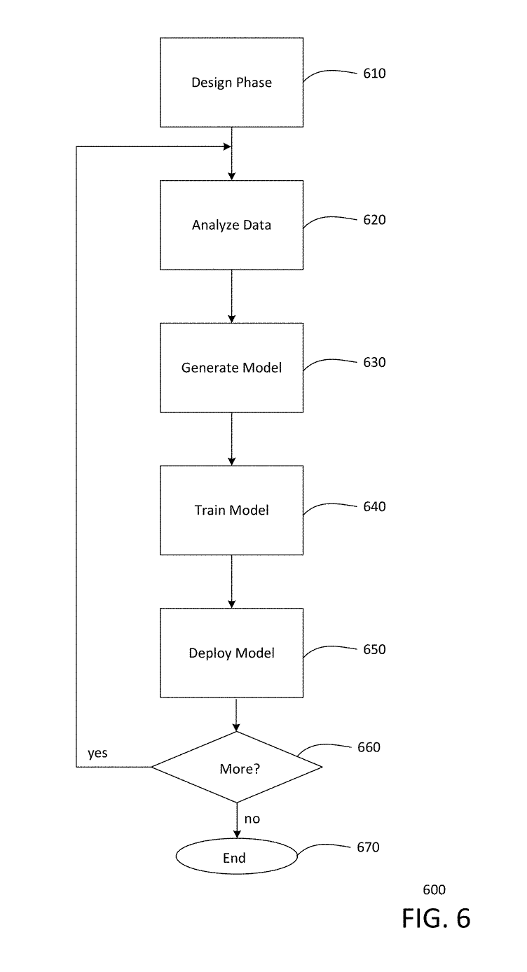

FIG. 6 shows an embodiment of a process flow 600 for generating a model. At step 610, the design phase of the process flow commences. For example, master user related data is obtained. The user related data may include user profile information from user registration, user answers to a questionnaire, user circumstance data, and user interaction data, including selection, applications and decisions of services, user data from data mining of external data sources as well as from other sources.

The master user related data is analyzed at step 620. For example, the data is analyzed based on services available through the recommendation system. In one embodiment, the data is analyzed based on each service available through the recommendation system. In one embodiment, the analysis includes defining a target value which indicates the high probability of success for a service being approved. Such analysis includes grouping users who apply and successfully receive a service (approval) and users who apply and do not receive the service (rejection).

At step 630, a model for the service is generated. The model may be a predictive model. For example, clustering, segmentation, decision tree or other predictive techniques may be used to generate the predictive model for the service. Alternatively, a rule based model is generated for the service. For example, rules may be defined based on the master user relate data.

The model is trained at step 640. For example, the model may be trained using a set of training data which includes known approval and rejection scenarios from the master user related data. The training can determine a score for the probability that the predicted value is correct. The model is tested with a set of test data which also has known success values. The training and test data are different sets of data. A confusion matrix is computed to determine accuracy of the prediction.

After the model is trained, it is deployed to the recommender runtime at step 650. At step 660, the process determines if there are more services to model. If so, the process returns to step 620 to analyze data. If all services have been modeled and deployed, the process terminates at 670.

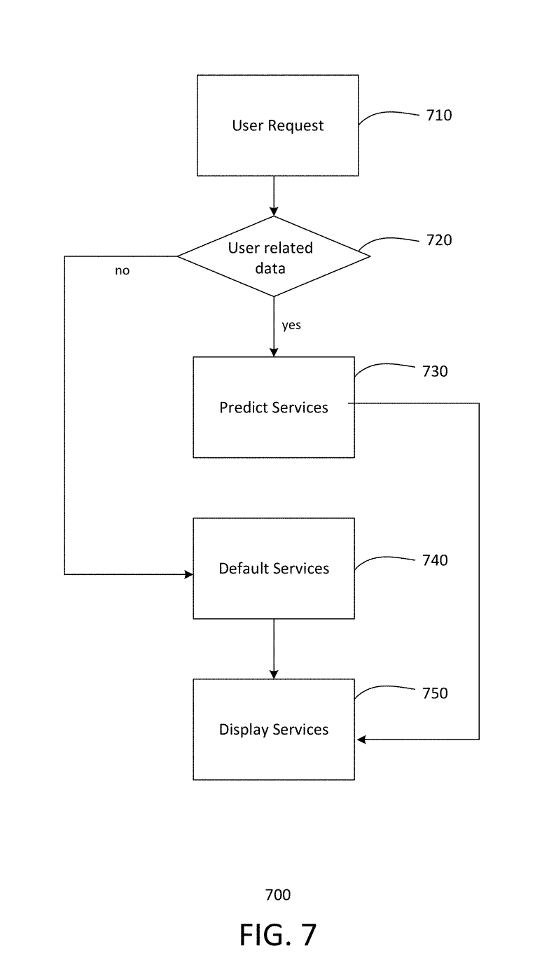

FIG. 7 shows an embodiment of a process flow 700 for generating a recommendation list of services by the recommendation system. At step 710, a user accesses the recommendation system. The user, for example, may be a registered or non-registered user. When the user accesses the system, a questionnaire may be provided. The user may provide user related data through the questionnaire. As discussed, the questionnaire may be optional.

At step 720, the process determines if there is user related data for the user. For example, user data may be provided from the questionnaire or from the master user related data. If there is user related data, it is used to generate a list of recommended services at step 730. For example, the list may be based on a model in the recommender runtime unit, such as a predictive or a rule based model. If no user related data is available, the process proceeds to step 740 to provide a default list of services. The list, for example, may contain the top 5 or 10 ranked services. Providing other number of top ranked services may also be useful. The list of services, whether recommended at step 730 or default at step 740, is displayed to the user using the UI at step 750. For example, the list is displayed in the recommender area of the UI.

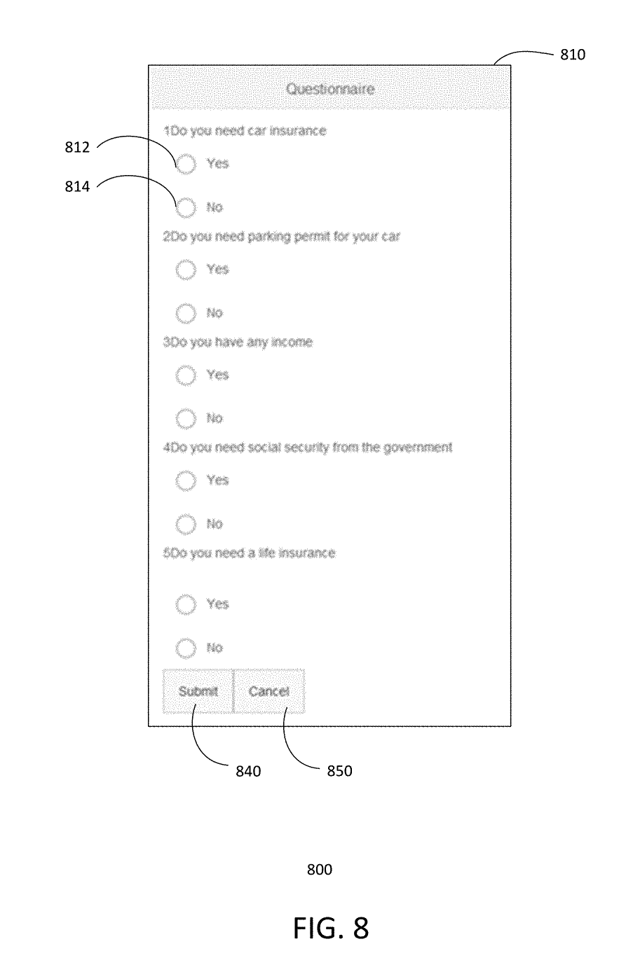

FIG. 8 shows an embodiment of an exemplary questionnaire 800. The questionnaire, for example, is presented in the App service area of the UI 810. As shown, the questionnaire includes a plurality of questions. Each question includes a yes radio button 812 and a no radio button 814. The questions are presented as yes/no questions. For example, answers to the questions are either in the affirmative or the negative. The answers are simple and provides user information which indicates the type of services needed based on the model. Once the questionnaire is completed, the user may submit it to the system by clicking on the submit button 840. Alternatively, the user may choose not to provide any user related information by clicking on the cancel button 850. The questionnaire may include additional or other types of questions.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer-implemented method for recommending services comprising:
collecting user related information of users of a recommendation system which forms master user related data, wherein
collecting user related information comprises
obtaining user related information provided by the users, and
mining external data sources which are external to the recommendation system to obtain user related information of users, and
the recommendation system includes a list of available services through the recommendation system;
generating a model by the recommendation system from analyzing the master user related data;
accessing the recommendation system by a user using a user interface on a user device;
determining by the recommendation system whether the recommendation system has user related data of the user, wherein
if the recommendation system has user related data of the user, a list of recommended services is generated based on the user related data using the model, and
if the recommendation system does not have user related data of the user, the list of recommended services is generated based on a default list of recommended services; and
displaying the list of recommended services to the user on the user interface of the user device.

2. The method of claim 1 wherein the master user related data comprises master user related data of registered users of the recommendation system.

3. The method of claim 1 wherein the master user related data comprises master user related data of registered and non-registered users of the recommendation system.

4. The method of claim 1 wherein user related information provided by the user comprises:
user related information provided directly by the user; and
user related information provided indirectly by the user.

5. The method of claim 1 comprises providing a questionnaire to the user to answer by the recommendation system, wherein if the user answers the questionnaire, the answers form a component of the user related data of the user.

6. The method of claim 1 wherein generating the model comprises:
defining a target value for a service available from the recommendation system, wherein the target value indicates a high probability of success for the service being approved;
generating the model for the service using a model analysis;
training the model using a training data set;
testing the model using a test data set; and
deploying the model if it passes testing.

7. The method of claim 1 generating the model comprises generating a model for each service available from the recommendation system.

8. The method of claim 1 generating the model comprises generating a predictive model using a predictive analysis.

9. The method of claim 1 wherein generating the model comprises generating a rule based model a rule analysis.

10. A system for recommending services comprising:
a frontend sub-system, wherein the frontend sub-system serves as a platform for the system, wherein the frontend sub-system comprises
a questionnaire unit for providing a user with a questionnaire to answer, and
a service recommender unit, wherein the service recommender unit displays a list of recommended services from available services provided by the system, wherein the list of recommended services
is based on user related data if user related data of the user is available, and
is based on a default list if no user related data of the user is not available; and
a backend sub-system, wherein the backend sub-system comprises
a database module, wherein the database module comprises
the available services of the system, and
master user related data of users of the system, wherein master user related data comprises
user related information provided by the users, and
user related information of users from mining external data sources which are external to the recommendation system, and
a processor module, wherein the processor module includes a recommender runtime unit, wherein the recommender runtime unit comprises a model which is used to analyze the user related data of the user to generate the list of recommended services which is passed to the service recommender unit.

11. The system of claim 10 comprises a virtual service library sub-system, wherein the virtual service comprises data services to facilitate communication services between the frontend sub-system and backend sub-system.

12. The system of claim 11 wherein the virtual service library sub-system decouples the frontend and backend sub-systems.

13. The system of claim 11 wherein the frontend subsystem further comprises:
a search unit; and
a catalog unit, wherein the catalog unit comprises a list of available services of the recommendation system, wherein the search unit searches the catalog unit based on user selecting keyword search.

14. The system of claim 13 wherein the search unit, the questionnaire unit, and the recommender unit correspond to screen elements of a user interface.

15. The system of claim 10 wherein:
the questionnaire unit comprises a publisher application service which is a subscriber application for writing data to the database module; and
the recommender unit comprises a subscriber application service which subscribes to the backend subsystem to receive the list of recommended services.

16. The system of claim 10 comprises an analytic tool for analyzing the master user related data in the database module to generate a predictive model.

17. A non-transitory computer-readable medium having stored thereon program code, the program code executable by a recommendation system having a processor and the non-transitory computer medium, the program code comprising:
collecting user related information of users of the recommendation system which forms master user related data, wherein
collecting user related information comprises
obtaining user related information provided by the users, and
mining external data sources which are external to the recommendation system to obtain user related information of users, and
the recommendation system includes a list of available services through the recommendation system;
generating a model by the recommendation system from analyzing the master user related data;
accessing the recommendation system by a user using a user interface on a user device;
determining whether the recommendation system has user related data of the user, wherein
if the recommendation system has user related data of the user, a list of recommended services is generated based on the user related data using the model, and
if the recommendation system does not have user related data of the user, the list of recommended services is generated based on a default list of recommended services; and
displaying the list of recommended services to the user on the user interface of the user device.

18. The non-transitory computer-readable medium of claim 17 wherein generating the model comprises:
defining a target value for each service available from the recommendation system, wherein the target value indicates a high probability of success for the service being approved;
generating each model for the service using a model analysis;
training each model using a respective training data set;
testing each model using a respective test data set; and
deploying each model after passing testing.

19. The non-transitory computer-readable medium of claim 18 wherein the model analysis comprises a predictive model analysis to generate predictive models.

20. The non-transitory computer-readable medium of claim 18 wherein the model analysis comprises a rule model analysis to generate rule based models.
